(19) United States
(12) Patent Application Publication
(10) Pub. No.: US 2003/0150170 A1
(43) Pub. Date: Aug. 14, 2003

(54) Roof covering

(76) Inventor: Hugo Weber, Waltenhausen (DE)

Correspondence Address: WILLIAM COLLARD, COLLARD & ROE, P.C., 1077 NORTHERN BOULEVARD, ROSLYN, NY, 11576, US

(21) Appl. No.: 10/332,322

(22) PCT Filed: Jul. 6, 2001
(86) PCT No.: PCT/EP01/07799

(51) Int. Cl. E04H 9/00; E04H 14/00; B62D 63/04; E04D 1/00

(52) U.S. Cl. 52/1; 52/3; 52/518

(57) ABSTRACT

The invention relates to a roof covering for cleaning and keeping the roofs of buildings clean, in particular of plant growth, or pollutants, comprising a sheet-like material (1) which reacts in co-operation with moisture. The sheet-like material forms a partly closed chamber, when in the state of being set upon an inferior roof element (5) and slowly releases the moisture accumulated in said chamber to the exterior.

The invention relates to a roof covering for cleaning the roofs of buildings and keeping them clean, in particular of plant growth or environmental pollution, comprising a metal which reacts in conjunction with moisture, the roof covering being produced from material in plate form by means of punching and/or bending and having a textured reaction surface.

A means of this kind for protecting house roofing from plant growth, in particular from growth in the form of moss and lichen, is disclosed by the Applicant in WO 98/01637. The production of the roof covering from material in plate form is carried out by means of punching and bending. A particular feature of this process is that the desired camber can be formed at the same time as the punching operation is being performed, with the result that, compared with a simple copper sheet, an attractive shape is obtained, and, in particular, the reaction surface is utilized for the moisture that flows off. Furthermore, it is easier for the roofer to fit the roof covering, since the roof covering, which corresponds in its outer shape to the roof tile or ridge tile, can be inserted or placed in a simple manner.

In addition, the production of the individual roof covering by means of punching provides the simple possibility of embossing protuberances in the reaction surface, so that the moisture running off has to cover as long a route as possible and, at the same time, a good distribution of the moisture over the roof surface is ensured. In addition, it is possible for perforations or openings in slit form to be provided at the same time as the punching procedure is taking place, by means of which it is also possible for liquid on the underside of the roof covering to react with the underside of the metal.

This makes it possible to achieve substantially a doubling of the reaction surface, so that a considerable reduction in the number of rows to be laid combined with a high degree of effectiveness can be achieved. Thus, it may be adequate for there just to be one row of such a roof covering in the vicinity of the ridge or else on the roof ridge.

Furthermore, in DE-A-41 30 365 or the roof covering is protected against moss growth that occurs over the years by mounting copper sheets in the visible region of the roof surface in such a way that they come into contact with rainwater and the rainwater that flows off flows over the largest possible surface area of the roof covering beneath the copper sheets. In the course of this, the rainwater releases constituents, in particular ions, from the copper sheets which counteract plant growth, in particular growth by moss and lichen, on the concrete or clay roofing tiles. It is preferable here for the copper sheets to be designed in the form of ridge-capping tiles and to be arranged along the ridge of the roof so that the moisture flowing off is able to flow off over the whole of the roof surface.

A disadvantage of the last-mentioned proposal, however, is that the copper sulfate solution produced is able to flow off relatively rapidly, and the effectiveness of these last-mentioned roof elements thus remains relatively low.

Accordingly, it is the object of the invention to improve the effectiveness of a roof covering of this kind for cleaning roofs of buildings and keeping them clean.

This object is achieved by a roof covering according to the features of claim 1. Advantageous developments of the invention are defined in the subclaims.

According to an embodiment of the invention, it is possible for a chamber for a water reservoir to be provided on the underside of the roof covering by means of the fold produced at the lower-lying, bottom end, from which reservoir the moisture can run off relatively slowly, thus significantly increasing the reaction time. All that is required in this regard is a single, web-shaped fold which is formed in a dimensionally accurate manner with respect to the roofing tile. Thus, it is also possible for the overall size of the reaction zone to be reduced, or for relatively small copper sheets to be used, resulting in an overall saving in material. In addition, the reduction in the size of the reaction zone thus made possible gives the roof covering a more uniform appearance. Furthermore, this size reduction improves ease of handling for the roofer.

A further advantageous refinement here is also that the fold at the bottom end edge can be produced by bending at the same time as the punching procedure is taking place on the upper side of the roof covering. The fold thus created in the form of a prolonged bottom edge additionally provides an attractive point of abutment for the clay or concrete tiles on the roof of the building, and increased dimensional stability.

A more detailed explanation and description of a preferred exemplary embodiment is given below with reference to the drawing, in which:

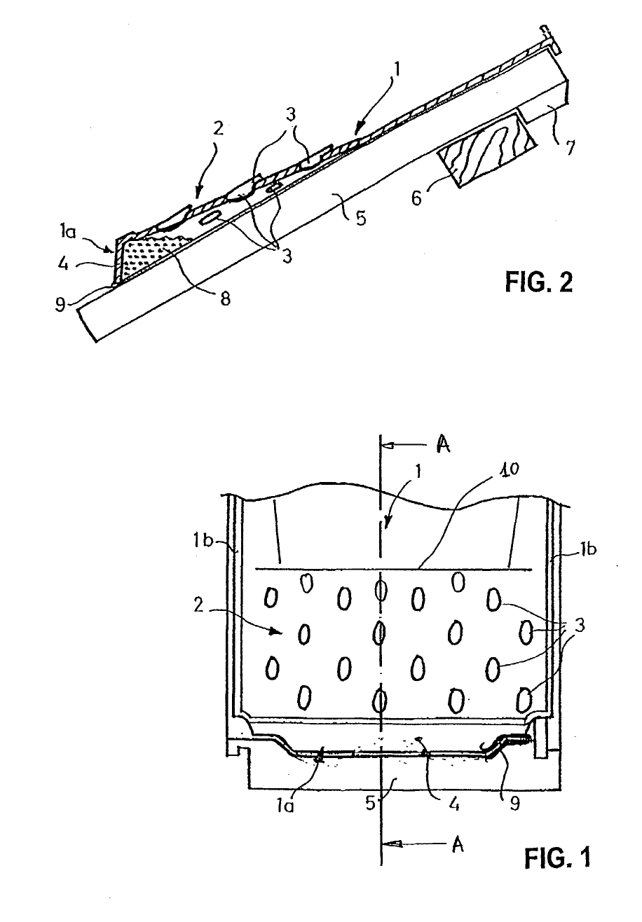

FIG. 1 shows a front view (or a plan view owing to the pitch of the roof) of the roof covering;

FIG. 2 shows a sectional view along line A-A in FIG. 1;

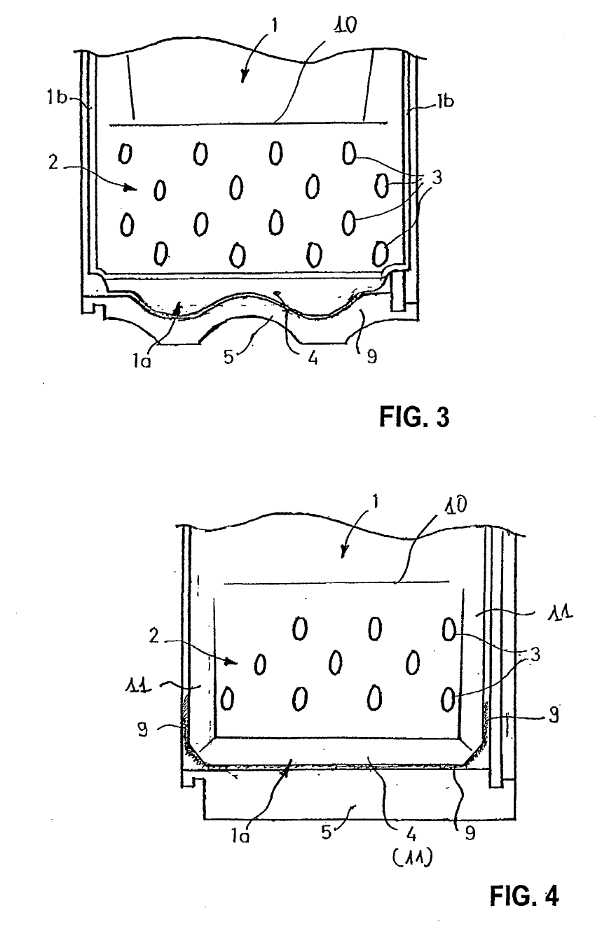

FIG. 3 shows a front view of the roof covering according to a second embodiment of the invention; and

FIG. 4 shows a front view of the roof covering according to a third embodiment of the invention.

FIGS. 1 and 2 show a roof covering 1 which is made to match the shape of a roof element or roofing tile 5 arranged underneath. The roofing tiles 5 here are fixed in the customary manner by means of a respective fastening nib 7 to a system of battens 6 or the roof framework. In place of roofing tiles, it is also possible for other roof elements, such as concrete roofing slabs or asphalt boards or the like, to be used as the base. The roof covering 1 made of material in plate form, in particular sheet copper, is then laid on or fitted over said roof elements. During production, said material is first punched out, a slight camber being incorporated by means of bending at the same time as the punching procedure is being carried out. In addition, a textured reaction surface 2 which is directed outward from the roof surface is formed by a large number of bosses (indicated by ovals in FIG. 2) and/or perforations 3 being punched in the reaction surface 2.

According to the innovation, a fold 4 in the form of a downwardly prolonged edge is formed in this case at the end 1a of the reaction surface 2, said end 1a pointing to the left here and lying at a lower level because of the pitch of the roof, with the result that the reaction surface 2 is positioned about 5 or 10° higher than the roofing tile 5. On the one hand, this textured reaction surface 2 with a punched-in perforations 3 inhibits liquid runoff on the reaction surface 2, with the result that the moisture that flows off (rainwater, water from snow, and the like) has to cover as long a route as possible along the perforations 3. On the other hand, some of the rainwater is passed through the perforations 3 to the underside of the reaction surface 2 and the acute-angled cavity 8 formed there. Water thus reaches a water reservoir 8 and is retained therein at least for a short period of time by means of the dimensionally accurate bottom fold 4. This substantially web-shaped fold 4 respectively provided at the lower-lying end 1a of the roof covering 1 thus achieves a situation where the moisture flows off out of the water reservoir 8 only with a delay and is thus able to react for a long time with the metal of the underside of the roof covering 1.

FIG. 1 shows the front view of the fold 4 bent toward the underside, said fold being formed in a die during the punching procedure or bending procedure. Here the barrier-type, runoff-inhibiting design of the fold 4 can be seen at the downwardly pointing end 1a, which fold 4 thus reliably prevents rapid water runoff from the chamber 8 owing to the dimensionally accurate way in which it is made to match the respective roof element shape or roofing tile 5.

FIG. 1 shows the roof covering 1 in its placed position on a roofing tile 5 in the form known as a reform tile, it also being possible for the latter to be replaced by other shaped concrete tiles or customary roofing tile shapes. Here, the arrangement of the textured reaction surface 2 with the perforations 3 which is situated on the roof covering 1 between the lateral edges 1b can also be seen, as can the fold 4 oriented downward at the end 1a. To bridge the minimal gap that exists at the bottom edge of said fold 4 bent downward in the form of a strip or web, it would also be possible to apply an additional sealing element 9, for example a sealing cord, a tube, a sealing compound or the like, to said bottom edge so as further to inhibit the moisture runoff from the water reservoir or chamber 8.

The downwardly directed fold 4 which is provided at the bottom end 1a and is in the form of a prolonged edge with respect to the roofing tile 5 thus provides a partitioning of the water reservoir 8 which is substantially impermeable to dripping water, with a high rate of water retention being achieved as a result. The fold 4 shown here (depicted in side view at preferably 60°, although other angles are also possible), optionally with the interposition of an applied tube portion or an adhesively bonded sealing element 9 in cord or tape form, thus lies in a dimensionally accurate manner in the “valley” of the reform tile and forms a water reservoir 8 which is fed through the perforations 3. A film or a sealing bead made of silicone material is also expedient as the sealing element 9, in order to retain water on the underside, i.e. in the water reservoir 8, for as long as possible. This means that the roof covering 1 or its respective reaction zone 2 can be made with relatively small dimensions while maintaining the same degree of effectiveness, since a large proportion of the reaction zone 2 is “shifted” onto the underside or into the water reservoir 8.

A further embodiment of the roof covering according to the invention is shown in FIG. 3. In this embodiment, the roof element 5 situated beneath the plate element is in the form of what is known as a Frankfurt tile. Consequently, the roof element does not have a single depression, but instead has two depressions which run parallel to one another in the flowoff direction and in which correspondingly formed portions of the fold 4 protrude. As in the embodiment in FIGS. 1 and 2, it is also the case here that, starting from the top and going downward, the plate element 1 initially runs tight against the roofing tile 5 in order then to become free of the roofing tile in the region of the line 10, as a result of which the acute wedge of the chamber 8 shown in FIG. 2 is formed.

A third embodiment of the roof covering according to the invention is shown in FIG. 4. In this embodiment, the roof element 5 has a planar surface without depressions, whereas the plate element 1 has a depression which is stamped in its bottom portion and in the region of which perforations or openings 3 are provided. In this embodiment, the fold 4 represents only one of the three oblique plate surfaces 11, between which the depression or the moisture-receiving pan of the plate element 1 is situated. A sealing compound 9 is preferably provided in the lower region of the plate element 1 between the supporting edge of the plate element 1 and the roofing tile 5, the intention of which is to make it more difficult, in a controlled manner, for the moisture or water situated in the depression of the plate element to flow off. The sealing compound 9 may advantageously have an adhesive function, so that, together with the partial sealing of the lower reception region for the moisture, a simultaneous fastening of the plate element to the roofing tile can be achieved.

1. A roof covering for cleaning the roofs of buildings and keeping them clean, in particular of plant growth or environmental pollution, comprising a material (1) in plate form which reacts in conjunction with moisture and which, when in the state of being placed on a roof element (5) situated underneath, forms at least one, partially closed chamber which slowly releases moisture received therein to the exterior.

2. The roof covering as claimed in claim 1, characterized in that the material in plate form constitutes a plate element (1) which has, on its lower side in the flowoff direction, a downwardly angled fold (4) which at least partially has the shape of a cross section of a depression of the roof element (5) that extends in the flowoff direction, with the result that, when in the placed state, the plate element blocks the depression in the flowoff direction by its fold (4) and hence forms the chamber as a moisture-receiving pocket.

3. The roof covering as claimed in claim 2, characterized in that the reaction portion (2) of the plate which adjoins the fold (4) and concomitantly forms the pocket is a flat portion which is angled upward from the plane of the roof element.

4. The roof covering as claimed in claim 3, characterized in that the fold (4) has a height of about 5 mm, with the result that a water-receiving, acute-angled pocket (8) is formed beneath the reaction surface (2).

5. The roof covering as claimed in either of claims 3 and 4, characterized in that an angle of about 120° is formed between the fold (4) and the reaction portion (2).

6. The roof covering as claimed in any of claims 2 to 5, characterized in that the fold (4) runs along the whole of the lower-lying end (1a) of the roof covering (1).

7. The roof covering as claimed in any of claims 2 to 7, characterized in that, with respect to the roof element (5) situated underneath, the fold (4) has a sealing element (9).

8. The roof covering as claimed in any of claims 2 to 7, characterized in that the fold (4) is formed in such a way that it continuously tapers off toward the lateral edges (1b) of the plate element.

9. The roof covering as claimed in any of claims 2 to 8, characterized in that the fold (4) is substantially web-shaped in design.

10. The roof covering as claimed in claim 1, characterized in that the material in plate form constitutes a substantially rectangular plate element (1) which has a depression which is open toward the flat roof element (5) and which, when the plate element is in the state of being placed on the roof element, forms the chamber as a moisture-receiving pocket.

11. The roof covering as claimed in claim 10, characterized in that the depression is formed in the lower portion of the plate and the plate otherwise lies flat on the roof element (5).

12. The roof covering as claimed in either of claims 10 and 14, characterized in that the depression is formed by deep drawing the plate.

13. The roof covering as claimed in any of claims 1 to 12, characterized in that the plate (1) is provided with openings (3) for the purpose of receiving moisture into the chamber.

14. The roof covering as claimed in any of claims 1 to 13, characterized in that the cross section of the chamber becomes greater in the flowoff direction.

15. The roof covering as claimed in any of claims 1 to 14, characterized in that the roof covering (1) is made of sheet copper.
